(19) United States
(12) Patent Application Publication
(10) Pub. No.: US 2021/0256249 A1
(43) Pub. Date: Aug. 19, 2021

(54) DETECTING VISUAL ATTENTION OF CHILDREN WITH AUTISM SPECTRUM DISORDER

(71) Applicant: Qatar Foundation for Education, Science and Community Development, Doha (QA)

(72) Inventors: Bilikis Banire, Doha (QA); Dena Al Thani, Doha (QA); Marwa Qaraqe, Doha (QA); Bilal Mansoor, Doha (QA)

(21) Appl. No.: 17/170,184

(22) Filed: Feb. 8, 2021

Related U.S. Application Data
(60) Provisional application No. 62/976,721, filed on Feb. 14, 2020.

(51) Int. Cl. G06K 9/00; G06T 7/73; G09B 19/00

(52) U.S. Cl. CPC G06K 9/00335; G06K 9/00248; G06T 2207/30201; G09B 19/00; G06T 7/73

(57) ABSTRACT

A method for detecting visual attention of a user includes capturing a face image of the user, determining coordinates of a plurality of facial landmarks of the face of the user for an attentive state and an inattentive state, calculating a distance between the facial landmarks, and determining whether the user is in the attentive state or the inattentive state based on the distance between the facial landmarks.

### PRIORITY CLAIM

This application claims priority to U.S. Provisional Patent Application No. 62/976,721, filed on Feb. 14, 2020, the entire contents of which are hereby incorporated by reference and relied upon.

### BACKGROUND

Attention is crucial for good learning outcomes, especially among children with autism spectrum disorder (“ASD”). Effective learning can improve deficits, such as social and communication skills. Atypical attention is prevalent in children with ASD, which raises concerns about their academic achievement. One of the ways to support the learning experience of children with ASD is through computer-based learning. Studies have used this approach to teach different skills on emotion recognition, social interaction, and vocabulary. Measuring attention in computer-based learning is usually based on the evaluation of user interaction. This measure may be challenging as compared to one-on-one learning. Thus, investigating objective methods of attention assessment for children with ASD in computer-based learning is imperative.

In recent years, the dynamics of attention assessment has shifted from physical evaluation to automated techniques. Some of the key advantages of these techniques include easy attention assessment, personalized pedagogical support, and adaptive learning. Many studies on automated attention assessment use a series of data collection methods. These methods include signals from brain activity, blood flow and heart rate, eye tracking, galvanic skin conductance, and face tracking. Among these methods, face tracking seems to be the most promising approach of collecting attentional behaviors. Face tracking uses webcam hardware, which is ubiquitous on personal computers and laptops.

Recent studies used facial features to develop a face-based model that measures learners' attention or engagement. These facial features are usually associated with the emotional and affective states of the learners. Arousal is one of the components of the reticular system that is responsible for sustaining attention. Other theories of attention have supported this phenomenon by postulating arousal as an effect of parallel processing and maintaining attention. These studies on attention theory highlighted the potential of facial features for attention assessment. Nonetheless, facial features need to be investigated for attention in children with ASD due to their atypical patterns of facial muscle activity. Understanding how the facial features of children with ASD may be instructive for assessing attention.

### SUMMARY

The present disclosure relates to a method of determining the attentive state of a child with autism spectrum disorder using a face-based attention recognition model with features that are directly associated with the objective annotation of attentional behaviors. Through the use of imaging technology, a user's (e.g., a child's) face can be analyzed for certain facial landmarks. The facial landmarks can be measured in relation to other facial landmarks.

In an example, the method may include selecting facial landmarks of a child with autism spectrum disorder. The distances between the facial landmarks can be calculated for pairs of landmarks during attentive and inattentive states. The distance between the facial landmarks can be instructive in assessing the attention level of the child. Based on the distances between the facial landmarks, a model can be generated. The developed model may be capable of measuring attention through the facial actions of a child with autism spectrum disorder.

An example method includes capturing, by an imaging device, a face image of the user, determining coordinates of a plurality of facial landmarks of the face of the user for an attentive state and an inattentive state, calculating a distance between the facial landmarks, and determining whether the user is in the attentive state or the inattentive state based on the distance between the facial landmarks.

In an example, the user may have autism spectrum disorder.

In an example, the distance between facial landmarks may be calculated using a Euclidean method.

In an example, the imaging device may be a webcam.

In an example, the face image may be captured during an attention task.

In an example, the attention task may include at least one of a low distraction task and a high distraction task.

In an example, the low distraction task may include a task without a distractor.

In an example, the facial landmarks may be located in at least one region of eyes, eyebrows, a nose, a jaw, and lips of the face image of the user.

In an example, the facial landmarks may include at least one point of a right top jaw, a right jaw angle, a gnathion, a left jaw angle, a left top jaw, an outer right brow corner, a right brow corner, an inner right brow corner, an inner left brow corner, a left brow center, an outer left brow corner, a nose root, a nose tip, a nose lower right boundary, a nose bottom boundary, a nose lower left boundary, an outer right eye, an inner right eye, an inner left eye, an outer left eye, a right lip corner, a right apex upper lip, an upper lip center, a left apex upper lip, a left lip corner, a left edge lower lip, a lower lip center, a right edge lower lip, a bottom lower lip, a top lower lip, an upper corner right eye, a lower corner right eye, an upper corner left eye, and a lower corner left eye.

In an example, the method may further include determining whether a first distance formed between first two facial landmarks and a second distance formed between second two facial landmarks are symmetrical.

In an example, the method may further include responsive to determining that the first distance and the second distance are symmetrical, determining that the user is in the attentive state.

In an example, the method may further include further comprising responsive to determining that the first distance and the second distance are not symmetrical, determining that the user is in the inattentive state.

Additional features and advantages of the disclosed methods and system are described in, and will be apparent from, the following Detailed Description and the Figures.

### BRIEF DESCRIPTION OF THE DRAWINGS

FIG. 1 illustrates an example method of recognizing attention of a child with autism spectrum disorder according to an embodiment of the present disclosure.

FIG. 2 illustrates a set of labeled facial landmarks according to an embodiment of the present disclosure.

FIG. 3 illustrates example distances between facial landmarks according to an embodiment of the present disclosure.

FIG. 4 illustrates attention and inattention facial actions during an attention task according to an embodiment of the present disclosure.

FIG. 5 illustrates a table of 20 distance-based features according to an embodiment of the present disclosure.

FIG. 6 illustrates a chart evaluating a participant independent model according to an embodiment of the present disclosure.

FIG. 7 illustrates a chart evaluating a participant dependent model according to an embodiment of the present disclosure.

FIG. 8 illustrates an example method of detecting visual attention of a user according to an embodiment of the present disclosure.

### DETAILED DESCRIPTION

The attention level of a child is correlated with the educational development of the child. The attention level of a child diagnosed with ASD may vary based on their environment and learning style. Children with ASD may require more care and support in order to increase their learning ability. As such, it is incredibly valuable to recognize and be aware of the attention level of a child with ASD.

In order to determine and recognize the attention of a child with ASD, an attention recognition model may be used. The model may be based on facial actions of the child. For example, facial actions may be a valuable source to measure the attention given by an individual. Through the use of facial tracking technology, a child's facial features may be monitored during particular activities. The facial features may be selected automatically. In another embodiment, the facial features may be preselected prior to the facial monitoring. The facial features may be distinguished from other facial features using coordinates. Through use of the coordinates, the distance between facial features may be measured. The distance between the facial features may be an important measurement during attentive and inattentive states. Determining the distance between the facial features may be a component in developing a model to recognize attention of a child with ASD.

The attention recognition model may be independent or dependent of the child with ASD. The model may generate values which are further classified to filter out distances between less important facial features. After determining the more useful distances, the model may be used to determine, based on the distances between the facial features, whether a child is in an attentive or inattentive state.

### EXPERIMENTAL VALIDATION

An objective of this experiment was to propose a face-based method to develop an attention recognition model. This method uses task performance for objective attention annotation, and distance-based feature selection to develop the model. The developed model may have the potential of measuring attention through the facial actions of the participants. This experiment may include three steps: model construction, recognition, and generalization. Firstly, model construction may be a process for training attention classifiers based on facial features captured during the experiment. Secondly, recognition may involve using the model to detect attention and inattention. Lastly, generalization may investigate how the model behaves when it is trained and tested on different groups of participants. The proposed method may also be applied to other performance-based tasks and populations aside from students with ASD. This experiment achieved the objective of face-based attention recognition model using the following research methods: (1) an attention recognition method with transformed facial features; (2) a simple factorial experimental design to elicit attentional behavior across different ASD and typically developing (“TD”) children participants; (3) a bi-directional evaluation of generalized attention recognition model.

The experiment proposed a face-based attention recognition model with features that are directly associated with the objective annotation of attentional behaviors. Also, the investigations on how the model generalizes across the ASD spectrum, TD, and attention tasks were explored. The scope of this experiment was examining: (1) attention recognition models for ASD and its generalizability among ASD and TD children; and (2) attention tasks with low and high levels of distraction in an attention task among the ASD group.

The attention task was simulated in a virtual classroom to induce the attentional behaviors of the participants (i.e., ASD and TD). The attention task consists of four different levels of audio-visual distractions: baseline, easy, medium, and hard. The virtual classroom used the desktop compared to an immersive experience that uses a head-mounted device (“HMD”). This experiment conducted the attention test in an isolated room free from external distractions. The participants sat in front of the 24-inch monitor attached with a webcam, with iMotions software. The software generated the facial landmark features of the participants in real-time during the test. The parent or special education teacher of the participant was present with the researcher at a different table with a 35-inch screen to monitor the experiment. The stakeholders were present to observe the experiment and manage the participant in case an unexpected incident occurred.

A total of 46 children between the ages of seven and 11 years participated in this experiment. Twenty clinically diagnosed children with ASD (ASD n=20, M=8.38, SD=1.35) under the DSM-IV-TR criteria. Twenty-six typically developing children from the same age range (TD n=26, M=8.57, SD=1.37) also participated in the experiment. The ASD group had 16 boys and four girls with mild to moderate ASD, while the TD group had 18 boys and eight girls. The inclusion criteria for children with ASD were: (a) children in the age range of seven to 11 years. (b) Children officially diagnosed as mild or moderate ASD. (c) TD children not diagnosed with ASD and other developmental disabilities. Parents of TD children filled the childhood autism spectrum test (“CAST”) questionnaire to identify any traces of ASD in the child. Typical children who scored less than 15 out of the 32 in the CAST questionnaire participated in the experiment.

This experiment simulated CPT in a virtual classroom where target stimuli were random alphabets displayed on the board for 1,400 milliseconds. The participants were instructed to click the keyboard when the letter X appeared. The test had four levels of distractions: baseline, easy, medium, and hard. At the baseline level, there was no distractor, while the easy level had distractors on the left side of the class. The medium level had more distractors both on the left and right sides of the classroom. At the hard level, the distractors were all over the classroom.

The participants underwent five different sessions of attention tasks in the simulated virtual classroom. The first session of the tasks was a trial for the participant. The essence of the trial session was to get the participants acquainted with the attention test and experimental environment. The remainder of the sessions had four different real experiments with varying distractions (none, easy, medium, and hard). A simple factorial design (2×4) was adopted for the experiment to observe the effects of two varying factors (distractions and ASD).

A total of 273,678 observation samples were obtained from four-levels of the attention test completed by 18 participants from the ASD group. Data collected from two participants in the ASD group could not be analyzed because they could not follow the test instructions. Among the obtained observation samples, 27,571 samples were annotated as attention, 3,733 samples were annotated as inattention, and 242,374 samples were annotated as unknown. The percentage ratio of attention to inattention was 83.34% to 16.66%, which indicated a significant class imbalance.

The proposed attention recognition method may include three phases: developing the attention recognition model, evaluating the model at the participant level, and the model generalization. In the first phase, the attention recognition model may use training data from the attention elicitation experiment with participants from the ASD group. During the attention elicitation experiment, the face tracking method may generate facial landmark coordinates with a webcam device and a commercial software biometric analysis. Attentional behaviors may be annotated based on correct clicks. In the second phase, the developed attention recognition model may be used in detecting attentional behaviors of the new participants in a virtual classroom. The last phase may evaluate how the attention recognition model generalized among other participants with different degrees of atypical attention and attention tasks. The attention recognition method may further include feature engineering, objective labeling, feature extraction, and modeling.

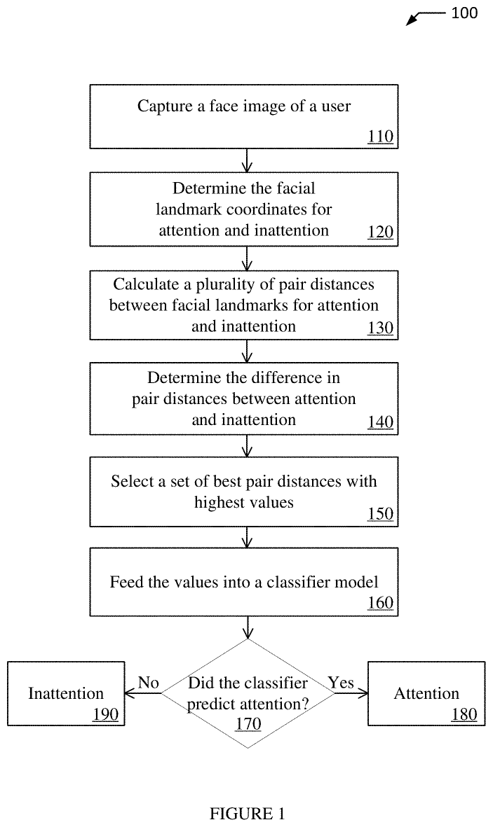

FIG. 1 describes a flowchart of an example method 100 for determining attention of a user according to an embodiment of the present invention. Although the example method 100 is described with reference to the flowchart illustrated in FIG. 1, it will be appreciated that many other methods of performing the acts associated with the method may be used. For example, the order of some of the blocks may be changed, certain blocks may be combined with other blocks, and some of the blocks described are optional.

In the illustrated example, a face image of a user may be captured (block 110). For example, the face image of the user may be captured with a webcam. Then, facial landmark coordinates for attention and inattention may be determined (block 120). Then, a plurality of pair distances between facial landmarks for attention and inattention may be calculated (block 130). The difference in the pair distances between attention and inattention may be determined (block 140). A set of best pair distances with highest values may be selected (block 150). For example, among the plurality of pair distances, the best 20 pair distances with highest performance values (e.g., differentiating attention behaviors from inattention behaviors) may be selected. Then, the values may be fed into a classifier model (block 160). For example, the best 20 pair distances may be fed into a classifier model. Then, the method may determine whether the classifier predicts attention (block 170). For example, different classifiers may be compared to determine which classifier performs better. Then, the method may use the classifier (e.g., the best classifier) to determine attention (block 180) and inattention (block 190).

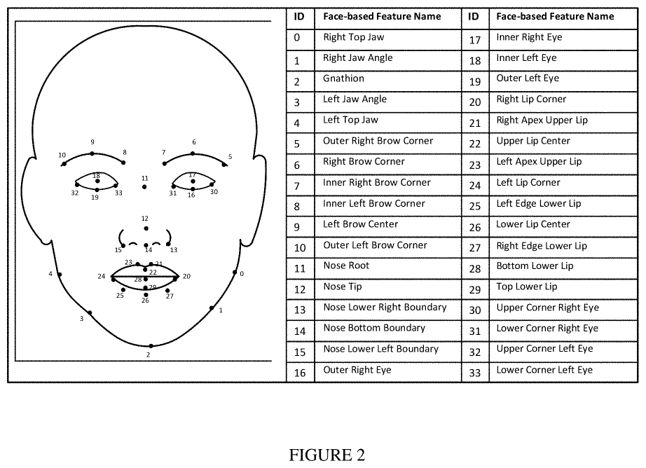

Face-based features were generated using a webcam device and iMotions software. This software uses a scientific technique of facial detection in real-time video devoid of head pose. iMotions software may locate a total of 34 facial landmarks frame-by-frame with x and y coordinates for each. As illustrated in FIG. 2, the facial landmarks generated by this software may cover five regions of the face: eyes, eyebrows, nose, lips, and jaw.

The objective evaluation of the attention of participants was based on task performance. Participants earn a score only when they make the right clicks. Thus the objective annotation was based on correct clicks. Other attention behavioral rules, such as looking at the target stimuli, were used for labeling attention and inattentional behaviors. These rules were in line with another experiment on attentional behaviors of children with ASD in computer-based learning. In this experiment, the on-task behaviors and off-task behaviors were compared against the correct response of the participants. The recorded sessions of the attention task were annotated as attention and inattention with iMotions software.

Feature extraction may be used to derive new set features from the original features that will lead to excellent model performance. Two steps that may be used to extract new face-based features from facial landmarks may include facial landmark transformation and normalization. The best features from the extracted features were selected and used to develop the attention recognition model. These feature extraction methods are described in detail below.

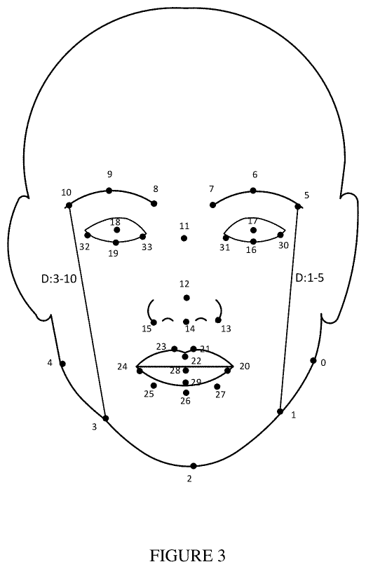

The two-class labels of 32 facial landmarks (i.e., attention and inattention) were explored for 64 features representing x and y coordinates for each landmark. Coordinates x and y in each facial landmark were treated as a separate feature. For example, landmark ‘0’ (i.e., top right jaw) with x and y coordinates had two correlation coefficients (i.e., positive and negative) with attentional behavior. These raw features made it difficult to understand how each landmark correlates with attentional behavior. Thus, the features were transformed using different techniques such as absolute values and pair distance between facial landmarks to understand the face regions that best describe attention. The model evaluation of the best features among the two transformation methods showed that pair distance was the better option, and the absolute value transformation was discarded. The pair distances were the distances between landmarks calculated using the formula in Equation 1. A total of 560 pair distances were generated. Two examples of the pair distances are shown in FIG. 3, where D:3-10 represents the distance between landmarks 3 and 10. D:1-5 represents the distance between landmarks 1 and 5, where x1 and y1 are coordinates of a landmark; x2 and y2 are coordinates of another landmark.

Pair Distance Formula: [(x1, y1), (x2, y2)]=\sqrt{(x2−x1)²+(y2−y1)²} (Equation 1)

Data samples need to be standardized for most machine learning algorithms to prevent biased predictions. Samples with more significant variance usually dominate other samples with lower variance, and this prevents the algorithm from correctly learning all the features. Some of the algorithms (e.g., Gaussian SVM) assume samples have a similar variance to secure unbiased learning. The transformed features were standardized to ensure data sample range restriction and close to normal distribution. This technique subtracts the mean value of the samples and divides their value by the standard deviation, as shown in Equation 2. Standardizing features results provide the mean of the distribution as 0, and the values are between −1 and 1. This approach ensures that each feature contributes to a consistent ratio in the model prediction. Each sample of standardized feature vectors is labeled as attention or inattention for developing the model, where Z is the standardized score, m is the mean of the training samples, and s is the standard deviation of the training samples.

$$Z = \frac{( x - m )}{s} \qquad ( Equation 2 )$$

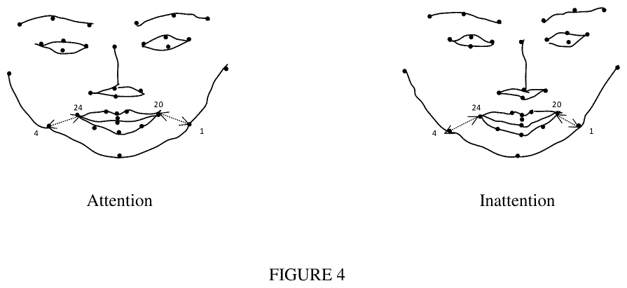

An objective of feature selection is to reduce computational cost. Feature selection reduces the training samples to the best features while maintaining the efficiency of the model. A small number of best features were selected from the 560 pair distances generated from 34 facial landmarks. A novel technique was used to differentiate attention from inattention behaviors using face-based features. It used the partitioning of the annotated transformed and normalized facial features into attention and inattention. The average samples from each label were plotted and visualized for possible differences, as shown in FIG. 4. Consequently, the differences in pair distances between the two class labels were calculated. The mean difference between all the feature vectors of attention and inattention samples showed that they were distinctive. The best features emerged by sorting them in descending order. They were selected to train the recognition model.

One of the common challenges of binary classification of the real-world problem is class imbalance. Some of the techniques used to resolve the issue of class imbalance were downsampling, oversampling, and ROC-AUC or F1-score as evaluation metrics. Downsampling of datasets involves reducing the sample size of a class with a higher number of observation samples to balance it with the number of other class samples. While this approach makes the model unbiased, it poses the challenge of losing essential data samples that may enhance the prediction accuracy of the model. In contrast, oversampling techniques generate synthetic data samples to increase the lower number of samples to match the class with a higher number. This approach may affect the accurate prediction of the power of the model due to the addition of sample data that were not real representations of the class. Lastly, ROC-AUC is used as the classification evaluation metric of the model instead of the classification accuracy.

In this experiment, the attention recognition model was developed using six different classifier algorithms. These algorithms include support vector machine (“SVM”), Decision Tree, Logistic Regression, Random Forest, Gradient Boosting, and K-Nearest Neighbor which were implemented in Scikit-learn. The performances of these models were compared using ten-fold cross-validation to select the best classifier. SVM outperformed other classifiers. Hyper-parameter tuning was applied to optimize SVM parameters (i.e., Gaussian kernel trick). The parameters were tuned based on values assigned C and gamma values of the SVM algorithm. The parameter values selected were from the following sets of values C=[1-26] and gamma=[0.001, 0.01, 0.1, 1, 10] using the cross-validation method. Selecting parameters through cross-validation evaluation can enhance the model's performance.

The results had significant findings. For example, the distances between the facial landmarks highlighted the landmarks for differentiating participants' behaviors into attention and inattention compared to raw features. These distances were highly discernible between the two class labels. For example, the distances between the facial landmarks 1-20 and 4-24 were almost symmetrical (e.g., having the same/similar distance) for attention labeled samples, but these distances were not similar for inattention (FIG. 4). Comparing the evaluation metrics between the participant-level models showed that the participant-dependent model performed better than the participant-independent model. The comparison between the participant-level model shows that the face-based model performs better on an individual basis. The bi-directional evaluation of the participant-independent model generalizes to new participants. This evaluation provided more comprehensive information than a one-way evaluation. The findings of the bi-directional assessment showed that the participant-independent model might not generalize to new participants or settings for face-based features.

The first step in the evaluation procedure compared the performance of the model developed with the raw-based features and distance-based features of the facial landmarks. Further comparisons in the model were developed with three different distance-based features presented in the following subsections. Also, both participant-dependent and participant-independent models were evaluated using ROC-AUC scores.

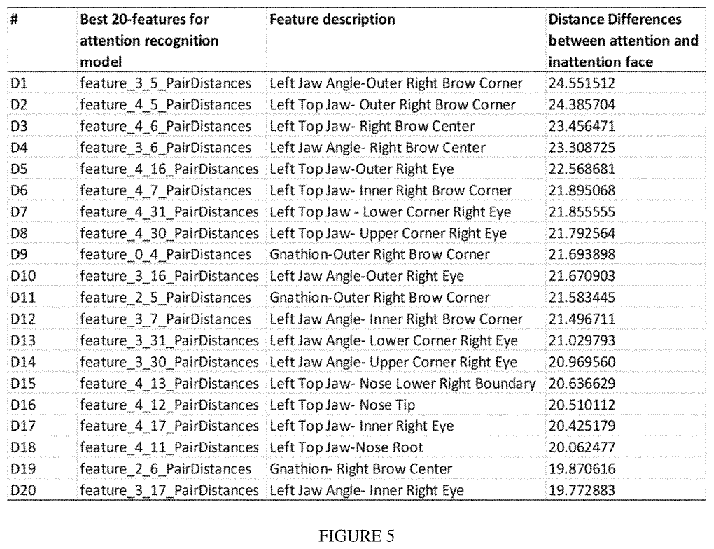

The evaluation metrics (“ROC-AUC”) used for three different best-selected distance-based features (i.e. 10, 20, and 30 features) were based on 10-fold cross-validations. Six different binary classifiers were compared, and the model with the best 20 and 30 features had a ROC-AUC score of 88.9%. The best 10 distance-based features had a ROC-AUC score of 87.3%. The model performance developed using the best 20 distance-based features was slightly lower than the raw-based features by around 2.2%. Thus, this experiment used a model with the best 20 distance-based features due to their higher performance and fewer features. FIG. 5 describes these 20 distance-based features. Five face regions emerged as prominent features in recognizing attention—jaw, eyes, eyebrows, nose, and gnathion. They uncovered brow, nose, eyes, and lips as the best face regions for the transition of emotions among children with high functioning ASD during task engagement.

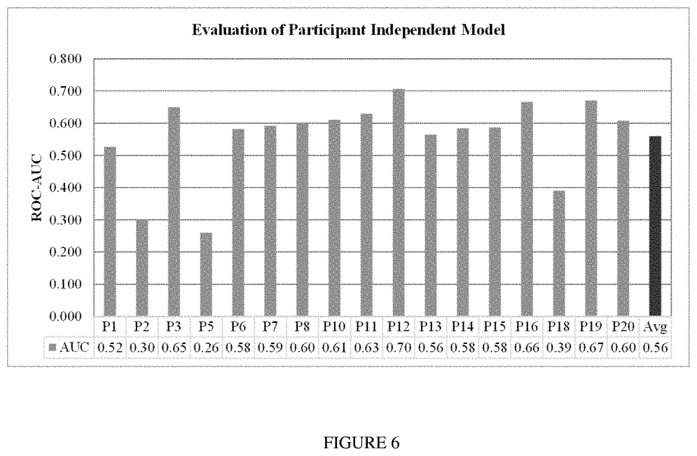

In some examples, in a participant-independent model evaluation, the attention recognition model used the data from a few participants for training. Consequently, it was tested on a new participant who was not part of the training data. The training and testing data were in the ratio of 78% and 22%, respectively. The average of the model performance for all participants was above chance (ROC-AUC=0.561), as shown in FIG. 6. This result implied that participant-independent performance would not lead to a random prediction. This result indicated that the distance-based model could be generalized for attention recognition among children with ASD.

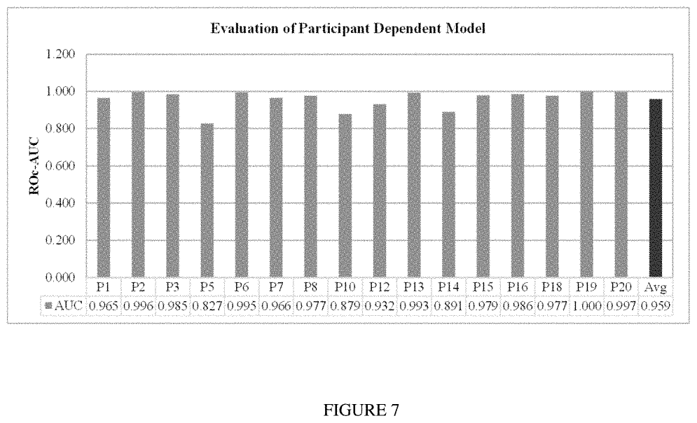

In other examples, in a participant-dependent model evaluation, the attention recognition model was trained and tested only on the data sample from each participant in this model. The averaged model performance for all participants was above chance (ROC-AUC=0.959) as shown in FIG. 7. This result illustrated that participant-dependent performance was better than the participant-independent model.

The result of this experiment demonstrated that the proposed face-based attention recognition model for children with ASD performed better with the participant-dependent model than the participant-independent model. However, the participant-independent recognition model performed above chance (AUC=0.561). The performance of the participant-independent model showed that it has the potential of generalizing across participants. The findings on model generalization across the ASD spectrum (i.e., mild and moderate) and TD will be discussed in detail below.

The number of participants from the ASD group who completed the experiment was lower than the TD group (ASD=18, TD=25). Hence, the number of participants from the TD group was reduced to 18 to match the ASD group. The total number of participants considered for the model generalization was 36 from each group. Next, the data samples were partitioned into training and testing sets at a ratio of 78% to 22%. This splitting ratio followed the standards of a train-test split where training data takes a higher proportion for the model to learn well from the data sample. The model used 78% of the data sample from children with ASD as training and tested with the remaining 22% for within-group model evaluation and 22% from TD children for cross-group evaluation. There was a two-way evaluation where 78% of the TD data samples were trained and tested on the remaining 22% and 22% from children with ASD. Model performance reliability may require several iterations. Thus, a nested cross-validation method at the participant's level with 50 iterations was used. Each participant appeared once in all iterations. Consequently, all performance scores were averaged for all the iterations.

The step used in this section may be repeated for the rest of the generalization metrics. The analysis of the model performance is discussed using ROC-AUC and F1-score to compare the two metrics. These metrics have been found to be the best metrics for imbalanced data. While ROC-AUC may handle the imbalance data from two directions in a binary class classification, F1-score may work well only in one direction. Exploring these metrics together can provide better insight into how attention and inattention affect model generalization.

The model evaluation using F1-score showed the model generalizes more in TD (F1-score=0.977) than in the ASD group (F1-score of 0.656). This model performance showed the disparity of attentional behavior among children with ASD compared to the TD group. This disparity may be associated with the heterogeneity in children with ASD. The F1-score of the ASD and TD within-group model dropped with a percentage difference of 14% and 6%, respectively, when compared with the cross-group model. This result indicates that generalizing the ASD model to TD participants is less efficient than the other way around. This result may be due to atypical attention among children with ASD. F1-score works better in the context of attentional behaviors (positive class) than inattentional behaviors (negative class). In this experiment, these findings may not generalize to inattention behavior.

The second metric (ROC-AUC), illustrated that the attentional model generalizes within groups. The within-group evaluation showed that the TD group (ROC-AUC=0.692) performed better than the ASD group (ROC-AUC=0.616). In the cross-group model, testing ASD model with TD data (ROC-AUC=0.365) gave less performance than testing TD model with ASD data (ROC-AUC=0.370). Additionally, the cross-group model performance dropped was lower as compared to within-group model. The decrease in model performance from within-group to cross-group showed that each group exhibits different attentional behaviors. Also, the model performance was above chance only for within-group evaluation and not for cross-group assessments. The performance of the within-group model indicates that the model only generalizes for within-group, not cross-groups.

Comparing the performance of the two evaluation metrics has shown that ROC-AUC had a lower performance score than the F1-score for within-group models. Additionally, the two metrics performed better in training the TD group for both within and cross-group models than the ASD group. The model performance for TD groups shows that the attention and inattention behaviors are more dispersed among children with ASD than among TD children. While the F1-score performed better for the within-group model, ROC-AUC was below chance. This comparison indicates that ASD and TD groups differ more in attentional behaviors.

According to the F1-score metrics, the performance of the model generalizes within-groups. This result indicates that the model generalizes more in the mild ASD group (F1-score=0.716) than in the moderate group (F1-score=0.627). The mild and moderate model performance indicates that atypical attention occurs more often among children with moderate ASD than in the mild ASD group. This finding also supports the evidence of more interventional support required by moderate ASD than mild ASD. The F1-score of the within-group model for moderate ASD (F1-score=0.627) improved by 6.2% when used to predict attention in mild ASD (F1-score=0.689). On the contrary, within-group model for mild ASD (F1-score=0.716) dropped by 3.3% when used to predict attention in moderate ASD group (F1-score=0.683). These results show that generalizing the attentional model within the mild ASD group has a higher performance than in the moderate ASD group. The high performance of the mild ASD model indicates that mild ASD has more defined attentional behaviors than the moderate ASD group. Additionally, attentional behavior of mild ASD may be seen in moderate ASD and not vice versa.

Similarly, the ROC-AUC evaluation showed that the attentional model only generalizes within-groups. This result implies that the within-group model for the moderate ASD group (ROC-AUC=0.548) was slightly better than the mild ASD group (ROC-AUC=0.545). This result illustrates more variation in inattentional behaviors among mild ASD than in moderate ASD children. In the cross-group model, training moderate ASD groups and testing on mild ASD groups (ROC-AUC=0.554) was slightly lower than training mild ASD groups and testing on moderate ASD groups (ROC-AUC=0.599). The cross-group model's performance was better than that of within-group by 0.6% (moderate-mild) and 5.4% (mild-moderate). The slight increase in performance from within-group to cross-group showed that both groups share more attentional behaviors than in within-groups. Additionally, the model performance was above chance for both within-group and cross-groups evaluation. This finding shows that the model generalizes for cross-group and within-group.

The comparison of the two evaluation metrics: F1-score and ROC-AUC illustrated that ROC-AUC had a lower performance score than F1-score for within- and cross-group models. This result indicates that attentional behaviors lead to better model performance among children with moderate and mild ASD. The average of the two metrics shows that model generalization is more efficient among children with mild ASD than among children with moderate ASD.

The F1-score metric shows that the model generalizes within-attention task types. Thus, it implies that the face-based attentional model generalizes more while training and testing high distraction tasks (F1-score=0.832) than low distraction tasks (F1-score=0.656). The second performance metric (ROC-AUC) showed that the within-task model for low distraction (ROC-AUC=0.616), performed better than that of the task with high distraction (ROC-AUC=0.593). This result indicates that attentional behaviors among children with ASD in attention tasks with high distractions might be attributed to lesser facial actions than in tasks with low distraction. The performance of the cross-task model illustrates that the model with a task with low distraction was better (ROC-AUC=0.844) than that of a task with high distraction (ROC-AUC=0.641). This result indicates that attention tasks with low distraction consist of more facial actions than the attention task with high distraction. The model performance rose from within- to cross-group in both attention-task types, with 12.8% in low distractions and 4.8% in high distractions. Additionally, the model performance was above chance in every direction. This performance shows that the model generalizes in every direction of attention-task types.

The average performance of the two evaluation metrics (F1-score and ROC-AUC) showed that generalizing model within attention task of high distraction was better than that of attention task with low distraction. Nevertheless, generalizing the cross-task model for tasks with low to high distractions was better than that of tasks with high to low distractions. This result implies that a high distraction task has fewer attentional behaviors which cannot be generalized compared to a low distraction task. Thus, it can be deduced that attentional behaviors are better defined in tasks with high distraction than in tasks with low distraction.

In an example, a proposed method for developing a face-based attention recognition model for children with ASD may have five steps. In the first step, the virtual classroom was adopted and refined to elicit attention and objective evaluation using task performance, as shown in FIG. 7. The objective measure of attention developed in the first step was used to annotate attentional behaviors in the second. Thirty-four facial landmarks with x and y coordinates were generated in real-time during the attention task in the third step. Consequently, the features were transformed to distance between facial landmarks. Twenty distance-based features were identified as distinctive features of differentiating attention and inattention. Also, the five best regions of the face for the attention recognition model were identified based on the distance-based features—jaw, eyebrows, eyes, nose, and gnathion. The fourth step compared the proposed method of model development (SVM) with other classifiers, and SVM had the best model performance. The final, fifth step evaluated the model generalization for ASD and TD groups and the different attention tasks.

According to the results from the proposed method, the performance of the participant-dependent and participant-independent models were above chance. However, the performance of the participant-dependent model had a better performance score than the independent model. This shows that the participant-dependent model works better for children with ASD. Studies by Bieberich and Morgan (2004); Czapinski and Bryson (2003); Yirmiya et al. (1989) have concluded that children with ASD exhibit different face-based attentional behaviors. Nonetheless, the generalized model makes attention evaluation easier and faster since it can be directly applied to new participants without initial profiling. Findings from this experiment have shown that children with less atypical attention exhibit similar attentional behaviors. For example, attentional behavior is more defined among children within-TD group than those within-ASD group, among children within-mild group than those within-moderate group, and among children within-high distraction task than those within-low distraction task. This finding is supported by Bioulac et al. (2018), who showed that there were similarities among children with high functioning autism (i.e., mild ASD) in face-based emotion during an engagement task. Conversely, the cross-group model shows that the face-based attentional behaviors exhibited vary among groups. For example, many of the face-based attentional behaviors in TD children are present among children with ASD, but not all the attentional behavior among children with ASD can be observed in the TD group. Also, face-based attentional behaviors exhibited by children with mild ASD are common in children with moderate ASD. However, not all the attentional behaviors displayed by moderate ASD groups can be seen among mild ASD ones. Lastly, the face-based attentional behaviors exhibited by children with ASD in attention tasks with low distraction are common in tasks with high distraction, but not all the attentional behavior in high task attention tasks can be seen in tasks with low distractions. Therefore, a generalizing face-based model for children with ASD and different attention types need to be applied cautiously.

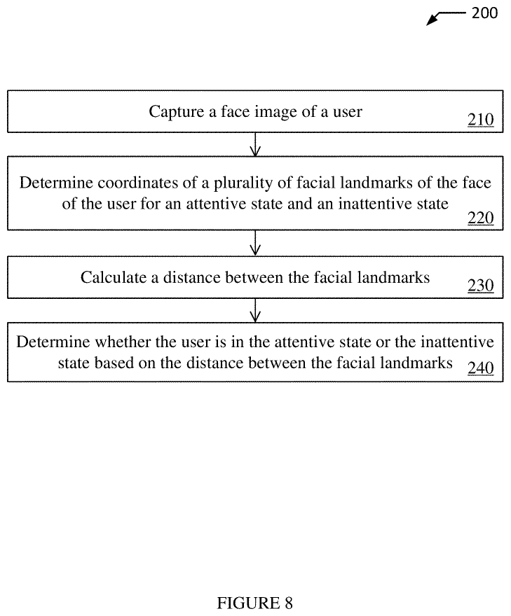

FIG. 8 illustrates an example method 200 of detecting visual attention of a user according to an embodiment of the present disclosure. Although the example method 200 is described with reference to the flowchart illustrated in FIG. 8, it will be appreciated that many other methods of performing the acts associated with the method may be used. For example, the order of some of the blocks may be changed, certain blocks may be combined with other blocks, and some of the blocks described are optional.

In the illustrated example, a face image of a user may be captured (block 210). For example, the face image of the user may be captured with a webcam. The face image may be captured during an attention task. For example, the user may be requested to click an input device while a predetermined symbol (e.g., X) appears on a screen. The attention task may also include at least one of a low distraction task and a high distraction task. The high distraction task may include more distractors (e.g., distractors on the screen) than the high distraction task. In some examples, the low distraction task may include a task without any distractor. In some examples, the user may have autism spectrum disorder.

The facial landmarks may be located in at least one region of eyes, eyebrows, a nose, a jaw, and lips of the face image of the user, for example, as illustrated in FIG. 3. In other examples, the facial landmarks may be located in any other suitable regions of the face. In some examples, the facial landmarks may include at least one point of a right top jaw, a right jaw angle, a gnathion, a left jaw angle, a left top jaw, an outer right brow corner, a right brow corner, an inner right brow corner, an inner left brow corner, a left brow center, an outer left brow corner, a nose root, a nose tip, a nose lower right boundary, a nose bottom boundary, a nose lower left boundary, an outer right eye, an inner right eye, an inner left eye, an outer left eye, a right lip corner, a right apex upper lip, an upper lip center, a left apex upper lip, a left lip corner, a left edge lower lip, a lower lip center, a right edge lower lip, a bottom lower lip, a top lower lip, an upper corner right eye, a lower corner right eye, an upper corner left eye, and a lower corner left eye.

Then, coordinates of a plurality of facial landmarks of the face of the user may be determined for attention and inattention (block 220). Then, a distance between the facial landmarks may be calculated (block 230). In some examples, distances between the facial landmarks may be calculated. In some examples, a set of preselected distances between preselected pairs of facial landmarks (e.g., best 20 distances D1-D20 as illustrated in FIG. 5) may be calculated. The distances between facial landmarks may be calculated using a Euclidean method, for example, as shown in Equation 1.

Then, whether the user is in the attentive state or the inattentive state may be determined based on the distance between the facial landmarks (block 240). In some examples, whether a first distance formed between first two facial landmarks and a second distance formed between second two facial landmarks are symmetrical may be determined. For example, it may be determined whether the first distance (D:1-20) between the facial landmarks at the right jaw angle (1) and the right lip corner (20) and the second distance (D:4-24) between the facial landmarks at the left top jaw (4) and the left lip corner (24) are symmetrical (e.g., the same/similar to each other). If it is determined that the first distance (D:1-20) and the second distance (D:4-24) are symmetrical, it may be determined that the user is in the attentive state. If it is determined that the first distance (D:1-20) and the second distance (D:4-24) are not symmetrical, it may be determined that the user is in the inattentive state. Accordingly, the presently disclosed method may advantageously determine the attentive/inattentive state of a child, for example, with autism spectrum disorder.

Reference throughout the specification to “various aspects,” “some aspects,” “an example,” “some examples,” “other examples,” or “one aspect” means that a particular feature, structure, or characteristic described in connection with the aspect is included in at least one example. Thus, appearances of the phrases “in various aspects,” “in some aspects,” “certain embodiments,” “an example” “some examples,” “other examples,” “certain other embodiments,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

The terminology used herein is intended to describe particular embodiments only and is not intended to be limiting of the present disclosure. As used herein, the singular forms “a”, “an” and “the” are intended to include the plural forms as well, unless otherwise indicated. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term ‘at least one of X or Y’ or ‘at least one of X and Y’ should be interpreted as X, or Y, or X and Y.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be configured to be executed by one or more processors, which, when executing the series of computer instructions, performs or facilitates the performance of all or part of the disclosed methods and procedures.

The examples may be embodied in the form of computer-implemented processes and apparatuses for practicing those processes. An example may also be embodied in the form of a computer program code containing instructions embodied in tangible media, such as floppy diskettes, CD-ROMs, DVD-ROMs, hard drives, or any other computer-readable non-transitory storage medium, wherein, when the computer program code is loaded into and executed by a computer, the computer becomes an apparatus for carrying out the method. An example may also be embodied in the form of computer program code, for example, whether stored in a storage medium, loaded into and/or executed by a computer, or transmitted over some transmission medium, such as over electrical wiring or cabling, through fiber optics, or via electromagnetic radiation, where when the computer program code is loaded into and executed by a computer, the computer becomes an apparatus for carrying out the method. When implemented on a general-purpose microprocessor, the computer program code segments configure the microprocessor to create specific logic circuits.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for detecting visual attention of a user, the method comprising:
capturing a face image of the user;
determining coordinates of a plurality of facial landmarks of the face of the user for an attentive state and an inattentive state;
calculating a distance between the facial landmarks; and
determining whether the user is in the attentive state or the inattentive state based on the distance between the facial landmarks.

2. The method of claim 1, wherein the user has autism spectrum disorder.

3. The method of claim 1, wherein the distance between facial landmarks is calculated using a Euclidean method.

4. The method of claim 1, wherein the imaging device is a webcam.

5. The method of claim 1, wherein the face image is captured during an attention task.

6. The method of claim 5, wherein the attention task comprises at least one of a low distraction task and a high distraction task.

7. The method of claim 6, wherein the low distraction task includes a task without a distractor.

8. The method of claim 1, wherein the facial landmarks are located in at least one region of eyes, eyebrows, a nose, a jaw, and lips of the face image of the user.

9. The method of claim 1, wherein the facial landmarks comprises at least one point of a right top jaw, a right jaw angle, a gnathion, a left jaw angle, a left top jaw, an outer right brow corner, a right brow corner, an inner right brow corner, an inner left brow corner, a left brow center, an outer left brow corner, a nose root, a nose tip, a nose lower right boundary, a nose bottom boundary, a nose lower left boundary, an outer right eye, an inner right eye, an inner left eye, an outer left eye, a right lip corner, a right apex upper lip, an upper lip center, a left apex upper lip, a left lip corner, a left edge lower lip, a lower lip center, a right edge lower lip, a bottom lower lip, a top lower lip, an upper corner right eye, a lower corner right eye, an upper corner left eye, and a lower corner left eye.

10. The method of claim 1, further comprising determining whether a first distance formed between first two facial landmarks and a second distance formed between second two facial landmarks are symmetrical.

11. The method of claim 10, further comprising responsive to determining that the first distance and the second distance are symmetrical, determining that the user is in the attentive state.

12. The method of claim 10, further comprising responsive to determining that the first distance and the second distance are not symmetrical, determining that the user is in the inattentive state.

13. A non-transitory machine readable medium storing instructions, which when executed by a physical processor, cause the physical processor to:
capture a face image of a user;
determine coordinates of a plurality of facial landmarks of the face of the user for an attentive state and an inattentive state;
calculate a distance between the facial landmarks; and
determine whether the user is in the attentive state or the inattentive state based on the distance between the facial landmarks.

14. The non-transitory machine readable medium of claim 13, wherein the user has autism spectrum disorder.

15. The non-transitory machine readable medium of claim 13, wherein the face image is captured during an attention task.

16. The non-transitory machine readable medium of claim 15, wherein the attention task comprises at least one of a low distraction task and a high distraction task.

17. The non-transitory machine readable medium of claim 13, wherein the facial landmarks are located in at least one region of eyes, eyebrows, a nose, a jaw, and lips of the face image of the user.

18. The non-transitory machine readable medium of claim 13, wherein the facial landmarks comprises at least one point of a right top jaw, a right jaw angle, a gnathion, a left jaw angle, a left top jaw, an outer right brow corner, a right brow corner, an inner right brow corner, an inner left brow corner, a left brow center, an outer left brow corner, a nose root, a nose tip, a nose lower right boundary, a nose bottom boundary, a nose lower left boundary, an outer right eye, an inner right eye, an inner left eye, an outer left eye, a right lip corner, a right apex upper lip, an upper lip center, a left apex upper lip, a left lip corner, a left edge lower lip, a lower lip center, a right edge lower lip, a bottom lower lip, a top lower lip, an upper corner right eye, a lower corner right eye, an upper corner left eye, and a lower corner left eye.

19. The non-transitory machine readable medium of claim 13, further storing instructions, which when executed by the physical processor, cause the physical processor to determine whether a first distance formed between first two facial landmarks and a second distance formed between second two facial landmarks are symmetrical.

20. The non-transitory machine readable medium of claim 19, further storing instructions, which when executed by the physical processor, cause the physical processor to, responsive to determining that the first distance and the second distance are symmetrical, determine that the user is in the attentive state.
